(19) United States
(12) Patent Application Publication
(10) Pub. No.: US 2014/0278612 A1
(43) Pub. Date: Sep. 18, 2014

(54) STAGED TICKET INVENTORY RELEASE USING AFFINITY MESSAGING

(71) Applicant: Live Nation Entertainment, Inc., Beverly Hills, CA (US)

(72) Inventor: John Carnahan, Los Angeles, CA (US)

(73) Assignee: Live Nation Entertainment, Inc., Beverly Hills, CA (US)

(21) Appl. No.: 14/216,741

(22) Filed: Mar. 17, 2014

Related U.S. Application Data
(60) Provisional application No. 61/788,091, filed on Mar. 15, 2013.

(51) Int. Cl. G06Q 10/02

(52) U.S. Cl. CPC G06Q 10/02
USPC 705/5

(57) ABSTRACT

A hybrid ticket messaging system is used to release ticket inventory information to subscribers and, more particularly, to integrate ticket inventory information with a third party site. Relevant interests are determined for the user based on a subscription message. Ticket availability is determined according to the relevant interests. An availability message is sent to the user reflecting the availability of the tickets using the third party site. The availability message is sent prior to release of the tickets to other users.

This application claims the benefit of U.S. Provisional Application No. 61/788,091 filed on Mar. 15, 2013, which is hereby incorporated by reference in its entirety for all purposes.

### BACKGROUND

This disclosure relates in general to releasing ticket inventory information to subscribers and, more particularly, but not by way of limitation, to integrating ticket inventory information with social media.

Online ticket purchase web sites are widely used and increasing in popularity. In the world of online ticket purchase, it is not uncommon that tickets are sold out within a certain time after they are being released. Often, ticket brokers like to constantly reserve large block of tickets with good seats to prevent other people from purchasing them, and then resell tickets on a secondary market with unreasonable price or as an denial of service attempt for online sales while they focus on in-person purchases. Therefore, good seats are unavailable on the primary market or require real ticket buyers to revisit and refresh website periodically. It can be time-intensive and frustrating to the most loyal fans who have to resort to the secondary market to purchase from brokers and scalpers. The ticket purchase websites often face with a dilemma, either try to post fewer amount of tickets online and lose revenue, or post all the tickets online and let them fall into ticket brokers' hands.

### SUMMARY

A hybrid ticket messaging system is used to release ticket inventory information to subscribers and, more particularly, to integrate ticket inventory information with a third party site. Relevant interests are determined for the user based on a subscription message. Ticket availability is determined according to the relevant interests. An availability message is sent to the user reflecting the availability of the tickets using the third party site. The availability message is sent prior to release of the tickets to other users.

In one embodiment, systems and/or methods for notifying users of ticket inventory in a selective manner are disclosed. In one step, a subscription message is received from a user that was originally posted using a third party site. Relevant interests of the user are determined from the message. Availability of tickets that correlate to the relevant interests is determined. An availability message is sent to the user reflecting the availability of the tickets using the third party site. The availability message is sent prior to release of the tickets to other users.

In another embodiment, a method for determining relevant interests of the user from the message is disclosed. In one step, a plurality of hash tags of the relevant interests is determined based on the subscription message. The plurality of hash tags is mapped into one or more ticket categories. A confirmatory message is sent to the user. The one or more ticket categories of the user is stored for giving future notice of the availability prior to release of the tickets to other users.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of a hybrid ticket messaging system.

FIG. 2 depicts a block diagram of an embodiment of ticket inventory management system.

FIG. 3 depicts a illustrating certain aspects of a tag match module, in accordance with certain embodiments of the present disclosure.

FIG. 4 illustrates a flowchart of an embodiment of a process for subscribing to a tweet sub-channel with messages relaying relevant ticket availability.

FIG. 5 illustrates a flowchart of an embodiment of a process for releasing blocks of tickets that can be purchased by the end user.

FIG. 6 illustrates a flowchart of an embodiment of a process for configuring ticket messaging from a subscription message.

FIG. 7 illustrates a flowchart of an embodiment of a process for mapping tags from a subscription message.

FIG. 8 illustrates a flowchart of an embodiment of an iterative process for tracking performance for a message subscriber.

A further understanding of the nature and advantages of various embodiments may be realized by reference to the following figures.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Referring first to FIG. 1, an embodiment of a hybrid ticket messaging system 100 is shown. Using any of a number of different third party messaging services 108, end user 116 can configure the hybrid ticket messaging system 100 to send messages with new ticket inventory. One example of a third party messaging service 108 is Twitter™. After following a particular handle for an artist, an event or a venue (or some combination or grouping thereof); a subscription message can be sent by a fan as a direct message to the handle that serves as a request for ticket information. A keyword or a symbol in the subscription message identifies it as a message for the ticket management system 104 and not a message for the artistic user 112 associated with the handle, for example, SUBSCRIBE or UNSUBSCRIBE could be keywords. The profile information for a handle could give instructions for subscribing to availability tweets related to the handle. As used herein, the term “hybrid” will generally refer to an entity that provides messaging service to the user or fan, which is different from the entity that provides ticket and runs the ticket management system. In some cases, the message service will be operated by the same entity that is providing online ticket purchasing, for example, TicketMaster™ web or TicketMaster™ mobile app may be used alone, or in combination with the social media. In other embodiments, the presented invention is not limited, to only Twitter™, or other social media, such as FACEBOOK™, LinkedIn™, GOOGLE™ PLUS, Skype™, etc. as the third party message service 108, but any social network outlet for subscribing to entertainment marketing that can have private or semi-private ticket offerings.

In the rubric of Twitter™, hash tags are used to identify the interest in categories of tickets. Additionally, the end user 116 could provide a geo hash tag code to indicate their location of interest for tickets. Some embodiments could determine location from the third party messaging service 108, cellular telephone or tablet or installed app on the phone or tablet. Other third party messaging services 108 could use different rubrics to relay interest and location. There could be different Twitter™ handles with this functionality where the handle is the normal channel that an artist, producer, label, venue, sport, event, and/or other channel would use to distribute tweets on other subjects. Additionally, a keyword or hash tag could optionally be used in the tweets or private messages to the end users 116 assigned to a category to differentiate the ticket availability tweet from other tweets that originate from the handle. In this way, the social network becomes the conduit for ticket message subscription and distribution without any specific functionality of the social network being needed.

Subscription messages are relayed from the third party messaging service 108 to the ticket management system 104. The one or more hash tags in the subscription message are mapped to one or more categories. Some embodiments may not need identification of specific tags in the subscription message instead relying on the content of the subscription message itself to determine the category of tickets that likely interest to the end user 116. Some embodiments may use a third-party database (for example, a GOOGLE™ search) or TicketMaster™ web or TicketMaster™ mobile app to search one or more ticket categories. Fuzzy logic, artificial intelligence, machine learning, support vector machine (SVM) and/or other techniques alone or in combination can be used to map the subscription messages to ticket categories. In some embodiments, mapping for a new subscription message may be performed by matching the keywords, symbols and/or other mapping metrics to a set of mapping training data for each ticket category. An example of such a mapping metrics is described in further detail below in connection with FIG. 7.

The ticket tweet or private message includes a notice and location for ordering the tickets. A link can also be provided in the ticket tweet to a web site or mobile app that when activated with bring the end user 116 to an interface for ordering the tickets. The link could be unique to a single end user 116 or group of end users 116 so that only that person or group could order from a set aside block of tickets, at least for some time period. The link could be to a web site for those that subscribed using the web version of Twitter™ or could be to the TicketMaster™ mobile app for those that subscribed using a mobile phone version of Twitter™. Additional credentials, coupon codes, username and/or password, or any other secret or semi-secret identifiers. The link preference could also be stated in the original subscription message rather than inferred. Updates to a particular subscription could be made with a replacement subscribe request after an unsubscribe message is sent to the handle. In some embodiments, a different subscribe request is presumed to replace an earlier request without requiring express unsubscription with a message.

The ticket availability tweets and/or direct/private messaging form a sub-channel in the end users 116 normal Twitter™ feed that would include other tweets associated with the handle, if any. For example, an artistic user 112 could have a handle of @AAA_Band, that the end user 116 subscribes to. A direct message to @AAA_Band saying, SUBSCRIBE #Denver #RedRocks would result in tweets with ticket availability for any show featuring the AAA Band at the Venue of Red Rocks Amphitheater in Denver. The ticket management system 104 can release ticket inventory in a staged way prior to general availability to the fans for a particular Twitter™ handle first or early in a staged roll-out of availability. Each user mapped to a ticket category would be given notice of the availability prior to a broader audience and/or the general public. There may be a fee (e.g. one-time fee, per-opportunity or monthly subscription fee) associated with a particular Twitter handle for it to release ticket inventory prior to general availability. Where an end user 116 follows the link to purchase tickets and indeed does complete the purchase, the end user 116 could optionally be unsubscribed automatically. In some embodiments, there may be a coupon or discount code listed together with the link for purchasing tickets, at least for some time period. In some embodiments, one availability message may expire after a predetermined time period (e.g. one hour) after releasing to one or more subscribers. If no purchase is detected, the same availability message may be released to other subscribers or to the general public using the same or a different coupon or discount code.

In the sole table, example hash tags and their corresponding ticket category are shown. The hash tag could be as specific as event serial number #90234875 for a particular show or as general as #LA for all shows in the Los Angeles area relevant to the handle the subscription message was sent to. For example, a message of “SUBSCRIBE #LA” to the @LV_Symphony handle would result in ticket availability messages for the Las Vegas Symphony when they traveled to Los Angeles. A plain English confirmation private or direct message saying the same could be sent to the end user 116 saying that and providing instructions for deleting the subscription if wrong.

TABLE
Hash Tag Mapping

| Control | Output |
|---|---|
| Voltage | Frequency |
| #Apollo | Apollo Theatre |
| #ABC | ABC Band |
| #LA | Los Angeles Tickets |
| #92037 | Venues Near 92037 Zip Code |
| #Jazz | Live Jazz Performances |
| #Cars | Cars Band |
| . . . | . . . |
| #90234875 | Ziggy Marley Show on Nov. 5, 2013 |
| | in the Staples ™ Arena |

In some embodiments, a message with one zip code of #92037 would result in ticket availability message with a group of zip codes (for example, any locations with zip code from 92000 to 93000) in order to list the nearby events for all associated zip codes. Number of desired tickets and a price range could also be specified in the hash tags. For example, a message of “SUBSCRIBE #LA Jazz No3” to the @LA_Symphony handle would result in ticket availability messages for the Los Angeles Symphony to be released when the number of available tickets is more than three.

The present invention is not limited to any particular code or symbol. In one embodiment, a pop-up filter window in the TicketMaster™ web, TicketMaster™ mobile app or third party messaging service 108 may be presented to the end user 116 in order to enter criteria, such as zip code, date of the event, time of the event, minimum ticket quantity, ticket price range, date by when message is to be sent, etc. for one or more subscriptions. A ticket inventory message would be sent when all or at least some criteria are met, which would result in releasing more valuable or directed message to the user in one embodiment. Targeting may result in more ticket purchases with a focused availability message in one embodiment. The end user 116 may adjust the criteria at any time. In some embodiments, based on request history from one or more end users 116, assumption would be made for the next mapping results based on some predetermined criteria and/or metrics. The message can be in the form of direct message via social media, text message from a cell phone, email message, etc. In some cases, the user will have an opportunity to repost the private/direct message to the public or through their social graph on the third party messaging service 108 where allowed or applicable.

In some embodiments, the ticket inventory management system may be configured to generate more than one categories of tickets for an event. Different subscriptions (for example, “SUBSCRIBE #POP” or “SUBSCRIBE #MADONNA” to the @LA_Concert handle) may result in the same event of “Madonna tour in Los Angeles” being offered to the subscriber, for example. Multiple configurations of subscription message or mapping of tickets into categories may be generated such that a rigid syntax is not required. Different categorizing of tickets may be released or made available to different message subscribers or end users 116. The preferences of a user, their purchase history, and other information that may be received from the user or the user's account may be used to generate a category specifically tailored to the user. For example, a subscriber might be mapped to their purchase history with the TicketMaster™ web or TicketMaster™ mobile app or other distribution channels, or even mapped to demographic information or identified/deidentified personal information. A fan who buys cheap seats may be offered select cheap seats through the ticket message, and another fan who has a very high income could be offered front row or in a hospitality suite.

In some embodiments, different users may have vastly different preferences and hence many different ticket categories may be generated. For example, one specific user may have strong preference for choosing events based on price range (any live concert in Las Vegas under $100). The available tickets may be grouped into categories based largely on price. In another example, one specific user may have strong preference for choosing events based on show time (for example, any Friday night shows in Las Vegas). The available tickets may be grouped into categories based largely on show times. In some cases, users may have strong preference for choosing an event based on the best sound quality seats (for example, 2013 Madonna tour in Las Vegas). The tickets with the best sound quality seats may be grouped into category with one price range; tickets with a lower sound quality seats may be grouped to another category with lower price range.

In addition to generating categories of tickets based on specific user preferences of histories, different mapping metrics may be generated for different Twitter™ handles based on their user's demographics, purchase histories, and the like. For example, Twitter™ handles such as fan followers for artists or events, attract a younger demographic than a physical ticket broker. Based on the demographics data, the tickets may be mapped into categories based on different metrics for real ticket buyer and ticket brokers. In some embodiments, user preferences and user purchase history may be used to calculate or change characteristics such as when a ticket purchased by the user, how it influences a metric, and/or how it influences the price for the rest of available tickets. The profile characteristics of user may be periodically analyzed to determine trends and/or profile changes to affect the customized offering to that user or a group of users.

Referring next to FIG. 2, an embodiment of a ticket management system 104 is shown in detail. A ticket engine 204 uses third party interfaces 212 to communicate with any number of third party messaging services 108. The ticketing engine 204 knows when to release blocks of tickets from ticket inventory 224 in a staged or controlled release. User accounts 228 store ticket categories for all the end users 116. The artist accounts 232 have information specifying how their tickets should be rolled-out with various options to automate the process. The end users 116 and artistic users 112 interact with the ticketing engine 204 using an interface 236, which allows ordering tickets or otherwise interacting with the ticket management system 104.

The tag match module 208 takes the keywords, hash tags or other content in the subscription message and matches that to event and artist information 216, 220 to determine ticket categories for each end user 116. The hash tags could relate to a band, event, venue, artist, writer, actor, geography, etc. The subscription message could also specify dates of interest, genres, language, dislikes, show times, target demographic of fan, etc. Additionally, the subscription message could indicate price or class of ticket, seating format (open seating, table seating, reserved seating, etc), seating preferences (front row, balcony, club level, etc.), time of day, etc. for the ticket category of interest.

In other embodiments, the interface 236 can be used to configure ticket tweets and other availability messaging. The interface 236 could allow modification of existing subscriptions, entering of new subscriptions, and deleting unwanted subscription. The interface 236 could be accessed using the web or mobile app. In some embodiments, the interface 236 could allow management of subscriptions for end users 116. For example, subscriptions may be grouped by artist, team, location, etc. The end user 116 would have a chance to change, cancel and/or delete the subscription for each ticket categories. The users associated with social media (for example, FACEBOOK™) may share the availability message within their friend group. Other embodiments could lock down the availability message with a unique code or credential authentication such that it cannot be easily shared.

With reference to FIG. 3, an embodiment of a illustrating certain aspects of a tag match module 208, in accordance with certain embodiments of the present disclosure is disclosed. The tag match module 208 is coupled to one or more match data repositories 300. Some or all the information of the match data repositories 300 could be stored using a topology shown in FIG. 2 using the artist information 220, event information 216, ticket inventory 224, user accounts 228, and artist accounts 232.

One or more metric information stores hold tags or ticket categories that might appear in a request or otherwise map to a request. For example metric information 310, user account information 329, user purchase history 324, event information 317, ticket categories 322, location information 312, artist information 321, event information 317, etc. all store information about users and tickets that are mapped to tags. Request query strings 320 are mapped to those tags such that words or word strings along with context and/or rules can be used to determine the relevant tags for a given query. User purchase history 324 includes user ticket request history and ticket purchase history. For example, purchasing front row seats for several events will result in a tag for #frontrow being assigned to the user.

In some embodiments, the data ranges of the metric information stores that are used to map the subscription into specific tags that may also be changed at any time, for different events, venues, and the like. For example, for one specific event, such a Super Bowl game, the angle of view of the stadium may be an important characteristic that reflects the value of the ticket and has a particular tag. For another type of events, such as a concert, the sound quality at each seat may be the most important characteristic that has a unique tag. Using different metric-based analysis for a user and ticket, tag matching is done by the tag match module.

Further, the tools may allow an inventory manager or event provider to change the metric information 310 based on new subscription or past sale performance to affect the tag mapping. The number of sections or price levels may be dynamically adjusted during the onsale period for an event. Adjustments may be made to increase revenues, increase sales, meet a sellout date, and the like. In some embodiments, ticket inventory message release schedule may also be used to adjust or change the mapping metrics. The release schedule may be timed or designed to increase the demand for the tickets, increase revenue, and/or increase sales rate compared to an all at once release of tickets.

In some embodiments, a confirmation message with the ticket categories could be sent as a direct message tweet to the end user 116. The confirmation message may provide different action options with instructions to the end user 116. For example, the end user 116 would have a chance to confirm, change, cancel and/or delete the subscription for each ticket category. When tickets become available, the end users for the corresponding tag are notified from the third party messaging service 108 through a ticket tweet in this embodiment.

To support many different third party messaging services 108, tags can be mapped to query strings, hashtags, interface elements, etc. The third party translation store 313 maps tags to the interface or strings for a particular third party messaging service 108 or context. For example, a tag of Front_Row could be mapped to #frontrow hashtag for Twitter™. In another example, an interface pulldown in a ticket ordering app could select Zone A for a venue, that would be mapped to a tag called Top_Tier for the tag match module 208.

With reference to FIG. 4, an embodiment of a process 400 for subscribing to a tweet sub-channel with messages relaying relevant ticket availability is shown. The depicted portion of the process begins in block 404 where an end user 116 follows a handle or ticket channel of interest. After observing the instructions for a subscription message by a user, a subscription message is formulated and sent by direct message from the end user 116 to the handle conforming to the rubric of the third party messaging service 108. The ticket management system 104 can poll for new direct messages or they can be pushed out as they arrive to the third party interfaces 212. After mapping the hash tags to ticket categories, a confirmatory direct message is sent to the end user 116 in block 412.

The confirmatory direct message is in plain English, but may have incorrect presumptions determined from the hash tags by the tag match module 208. Where there are imperfections or other confusion perceived, the end user 116 can modify the subscription by additional direct messages to the handle in block 416. Blocks 408, 412 and 416 can be repeated until the ticket category or tag is correct. In some embodiments, the mapping results may be associated with a probability factor or a percentage of closeness between the original subscription message and possible ticket categories for a certain artist and/or event. In block 420, direct messages show up in the Twitter™ feed for the end user 116 as ticket tweets or direct messages according to the subscription.

In some embodiments, the number of available tickets in the availability message may vary depending on how close the event is or how low the inventory is. For example, availability message may specify less ticket quantity available two weeks away from the event. In most cases, ticket broker would need some extra time prior to the event to post tickets online and resell them. By increasing the number of available tickets one week or 2 days away from the event, ticket availability message would benefit real fans or ticket buyers and attract fewer ticket brokers in one embodiment.

Referring next to FIG. 5, an embodiment of a process 500 releasing blocks of tickets that can be purchased by the end user 116 is shown. The depicted portion of the process begins in block 504 where it is determined that a block of tickets has become available. The availability could be preplanned as a staged rollout or a return of unsold tickets, for example. The tickets correspond to one or more ticket categories and the end users 116 for those ticket categories are determined by reference to the user accounts 228 in block 508 by the tag match module 208. A ticket tweet is sent by the ticket management system 104 to the third party messaging service 108 in block 512 by logging into the artistic user's account corresponding to their handle. The third party messaging service 108 sends the ticket tweet to one or more end users 116 in block 516. The ticket management system 104 can send messages simultaneously or overlapping in time to a number of third party interfaces 212.

Each end user 116 receives their respective tweet in block 520. The tweets can be customized per end user 116 in some embodiments or the same for a group of end users 116. An end user can take a code from the tweet, click on the link or just log into the ticket management system 104 to authenticate their access to the prerelease of tickets and interact with the interface 236. In some embodiments, the code from the tweet may be unique to each subscriber, and may expire after a predetermined time period. The user may optionally have additional user authentication in block 528 to access their account through the web or phone app. Any tickets are purchased in block 532. Optionally, the end user 116 can be unsubscribed automatically from more ticket tweets for the event once tickets are purchased or an option can be presented in the checkout process to stop further message tweets.

With reference to FIG. 6, an embodiment of a process 600 for configuring ticket messaging from a subscription message is shown. The depicted portion of the process begins in block 602, where some inventory of tickets is available or will be in the future. A third party messaging service 108 receives a subscription message for a handle in block 604. Those subscription messages may accumulate at a regular rate from all end users 116. The ticket management system 104 periodically or in real time gathers the direct messages for all handles that it is managing in block 608. There could be screening to separate subscription messages from other messages, such as fan or personal messages. The hash tags, keywords and other language in the subscription message are analyzed by the tag hash module 208 in block 612. Certain plain language that would not be helpful in selecting categories or tag is removed from the query. A mapping is made to ticket categories that related to artists and/or events, for example, in the query by the tag match module 208. That mapping is explained to the end user 116 by the ticket management system 104 sending a confirmation message in block 616 as a direct or private message to the end user 116. In this way, each subscription message is processed by the ticket management system 104.

A number of variations and modifications of the disclosed embodiments can also be used. For example, any third party messaging service 108 capable of messaging could be used instead of Twitter™. The messaging functionality in user forums, bulletin boards, listservs, commentary functions, and Facebook™ and other social network sites. For example, a user could friend a musician on Facebook™ before sending a direct message with hash tags or keywords that would subscribe the user to return messages relevant to ticket purchases for the user.

Some embodiments could periodically send predetermined messages through the public message channel that are determined by the ticket management system 104. For example, a message could be: “All our subscribed fans have received their customized ticket invitations,” “Justin174fan in San Diego just bought four front row seats,” “LivyLuLu2 just bought the thousandth ticket,” or “The LA show is 50% sold out with fan club purchases.” Any workflow of staged ticket releases and messages is possible for preprogramming.

Referring to FIG. 7, a flowchart of an embodiment of a process for mapping tags from a subscription message is shown. The depicted portion of the hash tags mapping process 700 begins in block 702, where one or more keywords, and/or symbols are determined from a subscription message, which originated from a fan. A search may be performed in block 704 by searching in a pre-existing ticket category or tag database within the interface 236 (for example, a TicketMaster™ ticket category search) or searching in a third-party database (for example, a GOOGLE™ search), to find one or more ticket categories. Matching the search results with the existing ticket categories if needed in block 706. In some embodiments, the resulting ticket category list of a subscription message may be prioritized based on user specified metrics in block 708 and/or based on user account history in block 712. A customized list of ticket categories and/or tags is returned to the end user 116 in block 716 in a plain language response.

In some embodiments, fuzzy logic, artificial intelligence, machine learning, support vector machine (SVM) and/or other techniques alone or in combination can be used to map the subscription messages to ticket categories or tags by the tag matching module 208. In some embodiments, a mapping training data for each ticket category may be built based on subscription history for one or more users. Mapping for new subscription message may be performed by matching the keywords, and/or other mapping metric to the mapping training data for each ticket category.

The interface 236 may generate alerts or notification prompting the inventory management by reviewing the ticket inventory and ticket grouping when certain thresholds have been met. For example, the inventory manager may be alerted to a drop in inventory below a specific threshold and may prompt the manager to reassess the grouping and/or hash tags assigned to ticket categories. Messaging to the subscribers or general public using the handle or channel can be specified according or in the future if rules and/or thresholds are met.

In some embodiments, metrics such as location, genres, price, seating preferences, dates of interest, and show times may be specified by user either within the subscription message or within a pop-up window. Other metric may be a score, numerical value, rating, and the like that reflects a measure of the event's desirability (e.g., its value or rating with respect to a desirability characteristic, such as nearness to an event, good seats with clear view of the event, etc.). Various search strings, criteria and metrics will be added to the request query strings 320 and/or to other mapping training functionality.

Referring to FIG. 8, a flow diagram of an embodiment of an iterative process for tracking performance 800 for a message subscriber is shown. In some embodiments, tracking performance of a Twitter™ handle, a user account, and/or an IP address may provide feedback to the ticket management system 104. The feedback would benefit real fans or ticket buyers and attract fewer number of ticket brokers or scalpers buying for the secondary market. User account information 805 may be used to track performance, together with a ticket inventory request counter 810, a ticket inventory message counter 815, and a ticket purchase counter 820. The ticket management system may determine whether this user or the IP address is a good user 825 by some predetermined threshold for each counter 810, 815, 820. Different actions may be triggered such as keep sending inventory message 830b or stop sending inventory message 830a. The procedure of tracking performance may be modified in step 835 if any changes are found in any steps. For example, twitter handles such as fan followers, for some artists or events, attract a younger demographic than a ticket broker. Based on the performance data the tickets may be mapped into categories for real ticket buyers based on metrics different than those for the physical ticket broker. For example, if a user has a higher number of ticket inventory message (e.g., number>100) and a lower number of purchased tickets (e.g., number<2), the inventory message service may be terminated. In another example, if the number of purchased ticket from a single account or IP address is more than 100 for one event, service termination may be triggered and a notice is generated to the ticket management system 104.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A method for notifying users of ticket inventory in a selective manner, comprising:
receiving a subscription message at a first party system from a user, wherein:
the subscription message was originally posted using a third party site by the user;
the subscription message is being directed by the user to an account of a performer or a venue which is one of a plurality of accounts of the third party site; and
the first party system is independent from the third party site;
determining relevant interests of the user from the subscription message using a machine algorithm by the first party system;
correlating the relevant interests of the user with by first party system;
determining availability of tickets that correlate to the relevant interests by the first party system; and
sending availability of tickets from the first party system to the account of the performer or the venue at the third party site, wherein:
the third party site sends an availability message to the user reflecting the availability of the tickets using the third party site, and
the availability message is sent prior to release of the tickets to other users.

2. The method for notifying users of ticket inventory using a third party site as recited in claim 1, wherein the availability message has a link to an interface for purchasing the tickets.

3. The method for notifying users of ticket inventory using a third party site as recited in claim 2, wherein the interface is a website.

4. The method for notifying users of ticket inventory using a third party site as recited in claim 2, wherein the link comprises a uniform resource locator (URL) for launching a mobile application.

5. The method for notifying users of ticket inventory using a third party site as recited in claim 1, wherein determining relevant interests of the user from the subscription message using a machine algorithm by the first party system comprises:
determining a plurality of hash tags of the relevant interests based on the subscription message by the first party system;
mapping the plurality of hash tags into one or more ticket categories by the first party system;
sending a confirmatory message to the user from the first party system to the account of the performer or the venue at the third party site; and
storing the one or more ticket categories at a first party system of the user for giving future notice of the availability prior to release of the tickets to other users.

6. The method for notifying users of ticket inventory using a third party site as recited in claim 1, wherein the subscription message includes a location of the user.

7. The method for notifying users of ticket inventory using a third party site as recited in claim 1, wherein the availability message expires within a predetermined time period for purchasing the tickets.

8. The method for notifying users of ticket inventory using a third party site as recited in claim 1, wherein receiving the subscription message at a first party system comprises receiving at least one of a plurality of specified metrics selected from location, genres, price, seating preferences, dates of interest, and show times.

9. The method for notifying users of ticket inventory using a third party site as recited in claim 8, wherein sending the availability of tickets is at least partially based on the plurality of specified metrics.

10. A ticket inventory notification system comprising:
one or more processors; and
one or more memories coupled with the one or more processors, wherein the one or more processors and the one or more memories are configured to:
receive a subscription message at a first party system from a user, wherein:
the subscription message was originally posted using a third party site by the user;
the subscription message is being directed by the user to an account of a performer or a venue which is one of a plurality of accounts of the third party site; and
the first party system is independent from the third party site;
determine relevant interests of the user from the subscription message using a machine algorithm by the first party system;
correlate the relevant interests of the user with by first party system;
determine availability of tickets that correlate to the relevant interests by the first party system; and
send availability of tickets from the first party system to the account of the performer or the venue at the third party site, wherein:
the third party site sends an availability message to the user reflecting the availability of the tickets using the third party site, and
the availability message is sent prior to release of the tickets to other users.

11. The ticket inventory notification system as recited in claim 10, wherein the availability message has a link to an interface for purchasing the tickets.

12. The ticket inventory notification system as recited in claim 11, wherein the interface is a website.

13. The ticket inventory notification system as recited in claim 11, wherein the link comprises a uniform resource locator (URL) for launching a mobile application.

14. The ticket inventory notification system as recited in claim 10, wherein the one or more processors and the one or more memories are further configured to:
determine a plurality of hash tags of the relevant interests based on the subscription message by the first party system;
map the plurality of hash tags into one or more ticket categories by the first party system;
send a confirmatory message to the user from the first party system to the account of the performer or the venue at the third party site; and
store the one or more ticket categories at a first party system of the user for giving future notice of the availability prior to release of the tickets to other users.

15. The ticket inventory notification system as recited in claim 10, wherein the subscription message includes a location of the user.

16. The ticket inventory notification system as recited in claim 10, wherein the availability message expires within a predetermined time period for purchasing the tickets.

17. The ticket inventory notification system as recited in claim 10, wherein receiving the subscription message at a first party system comprises receiving at least one of a plurality of specified metrics selected from location, genres, price, seating preferences, dates of interest, and show times.

18. The ticket inventory notification system as recited in claim 17, wherein sending the availability of tickets is at least partially based on the plurality of specified metrics.
